(19) United States
(12) Patent Application Publication
(10) Pub. No.: US 2026/0238317 A1
(43) Pub. Date: Aug. 13, 2026

(54) Beam Failure Detection and Candidate Beam Detection Operations for Multi-Receiver Downlink

(71) Applicant: Apple Inc., Cupertino, CA (US)

(72) Inventors: Xiang CHEN, Palo Alto, CA (US); Dawei ZHANG, Saratoga, CA (US); Haitong SUN, Saratoga, CA (US); Jie CUI, San Jose, CA (US); Qiming LI, Beijing (CN); Yang TANG, San Jose, CA (US)

(21) Appl. No.: 19/155,433

(22) PCT Filed: Feb. 14, 2023
(86) PCT No.: PCT/CN2023/075992

§ 371 Date: Aug. 11, 2025

(51) Int. Cl. H04B 7/06; H04B 17/318

(52) U.S. Cl. CPC H04B 7/06964; H04B 7/0626; H04B 17/328

(57) ABSTRACT

A user equipment (UE) communicates with a base station having a first transmission and reception point (TRP) and a second TRP. The UE is configured to determine a beam failure for a first beam transmitted by the first TRP and perform a candidate beam detection (CBD) operation to evaluate candidate beams for communicating with the first TRP, wherein the CBD operation comprises determining whether each candidate beam is compatible with an active beam being transmitted to the UE by the second TRP.

### TECHNICAL FIELD

The present disclosure generally relates to wireless communication, and in particular, to beam failure detection and candidate beam detection operations for multi-receiver downlink.

### BACKGROUND

For single downlink (DL) reception or single Angle of Arrival (AoA) reception, the beam failure detection and recovery procedure for a user equipment (UE) has been defined. However, UEs may be able to simultaneously receive two DL receptions or two AoA receptions. Operations related to beam failure detection (BFD), candidate beam detection (CBD), and beam failure recovery (BFR) in the two DL reception scenario remain undefined.

### SUMMARY

Some exemplary embodiments are related to a method performed by a user equipment (UE) communicating with a base station having a first transmission and reception point (TRP) and a second TRP. The method includes determining a beam failure for a first beam transmitted by the first TRP and performing a candidate beam detection (CBD) operation to evaluate candidate beams for communicating with the first TRP, wherein the CBD operation includes determining whether each candidate beam is compatible with an active beam being transmitted to the UE by the second TRP.

Other exemplary embodiments are related to a user equipment (UE) having a transceiver configured to communicate with a base station having a first transmission and reception point (TRP) and a second TRP. The UE also has a processor communicatively coupled to the transceiver and configured to determine a beam failure for a first beam transmitted by the first TRP and perform a candidate beam detection (CBD) operation to evaluate candidate beams for communicating with the first TRP, wherein the CBD operation includes determining whether each candidate beam is compatible with an active beam being transmitted to the UE by the second TRP.

Still further exemplary embodiments are related to a method performed by a base station that is communicating with a user equipment using a first beam from a first transmission and reception point and a second beam from a second TRP. The method includes receiving a beam failure detection (BFD) notification from the UE indicating that the first beam of the first TRP has experienced a beam failure and determining whether the BFD notification comprises a new candidate beam to communicate with the UE using the first TRP.

Additional exemplary embodiments are related to a base station having a transceiver configured to communicate with a user equipment (UE) and a processor communicatively coupled to the transceiver and configured to receive a beam failure detection (BFD) notification from the UE indicating that the first beam of the first TRP has experienced a beam failure and determine whether the BFD notification comprises a new candidate beam to communicate with the UE using the first TRP.

### BRIEF DESCRIPTION OF THE DRAWINGS

FIG. 1 shows an exemplary network arrangement according to various exemplary embodiments.

FIG. 2 shows an exemplary UE according to various exemplary embodiments.

FIG. 3 shows an exemplary base station according to various exemplary embodiments.

FIG. 4 shows an exemplary network arrangement with two transceiver points according to various exemplary embodiments.

FIG. 5 shows a first flow diagram for UE BFR operations according to various exemplary embodiments.

FIG. 6A shows a second flow diagram for UE BFR operations according to various exemplary embodiments.

FIG. 6B shows a third flow diagram for UE BFR operations according to various exemplary embodiments.

FIG. 7A shows a first flow diagram for network behavior for BFD/CBD according to various exemplary embodiments.

FIG. 7B shows a second flow diagram for network behavior for BFD/CBD according to various exemplary embodiments.

### DETAILED DESCRIPTION

The exemplary embodiments may be further understood with reference to the following description and the related appended drawings, wherein like elements are provided with the same reference numerals. The exemplary embodiments relate to improvements to UE and network handling of beam failure detection, candidate beam detection, and beam failure recovery.

The exemplary embodiments are described with regard to a UE. However, reference to a UE is merely provided for illustrative purposes. The exemplary embodiments may be utilized with any electronic component that may establish a connection to an accessory device and is configured with the hardware, software, and/or firmware to exchange information and data with accessory devices. Therefore, the UE as described herein is used to represent any electronic component.

The exemplary embodiments are also described with regard to a fifth generation (5G) New Radio (NR) network and a next generation node B (gNB). However, reference to a 5G NR network and a gNB is merely provided for illustrative purposes. It should be understood that the exemplary embodiments may also be implemented in other types of networks, including but not limited to LTE networks, future evolutions of the cellular protocol, or any other type of network.

The gNB may be configured with multiple transmission and reception points (TRPs). Throughout this description, a TRP generally refers to a set of components configured to transmit and/or receive a beam. In some embodiments, multiple TRPs may be deployed locally at the gNB. For example, the gNB may include multiple antenna arrays/panels that are each configured to generate a different beam. In other embodiments, multiple TRPs may be deployed at various different locations and connected to the gNB via a backhaul connection. For example, multiple small cells may be deployed at different locations and connected to the gNB. However, these examples are merely provided for illustrative purposes. Those skilled in the art will understand that TRPs are configured to be adaptable to a wide variety of different conditions and deployment scenarios. Thus, any reference to a TRP being a particular network component or multiple TRPs being deployed in a particular arrangement is merely provided for illustrative purposes. The TRPs described herein may represent any type of network component configured to transmit and/or receive a beam.

In single downlink reception (which may also be referred to as single Angle of Arrival (AoA) reception), beam failure detection (BFD) and beam recovery operations are well known to one of skill in the art. First, a UE may detect a beam failure for reference signals (RSs) in a set q̅₀. Simultaneously, the UE may measure and evaluate one or more candidate beams for reference signals in a set q̅₁. The UE may determine that a predefined threshold of beam failures has been satisfied. In this instance, the UE is faced with two options. If the serving cell is an SCell, the UE may transmit a Beam Failure Recovery (BFR) Medium Access Control (MAC) Control Element (CE) to the serving SCell. Alternatively, if the serving cell is an SpCell, the UE may instead initiate a Random Access procedure with the Serving SpCell.

However, these solutions for single DL reception may not be ideal for two DL reception. Several areas of UE behavior in multi-receiver chain downlink reception remain undefined. The exemplary embodiments relate to UE and network operations for beam failure detection, candidate beam detection, and beam failure recovery in multi-receiver scenarios.

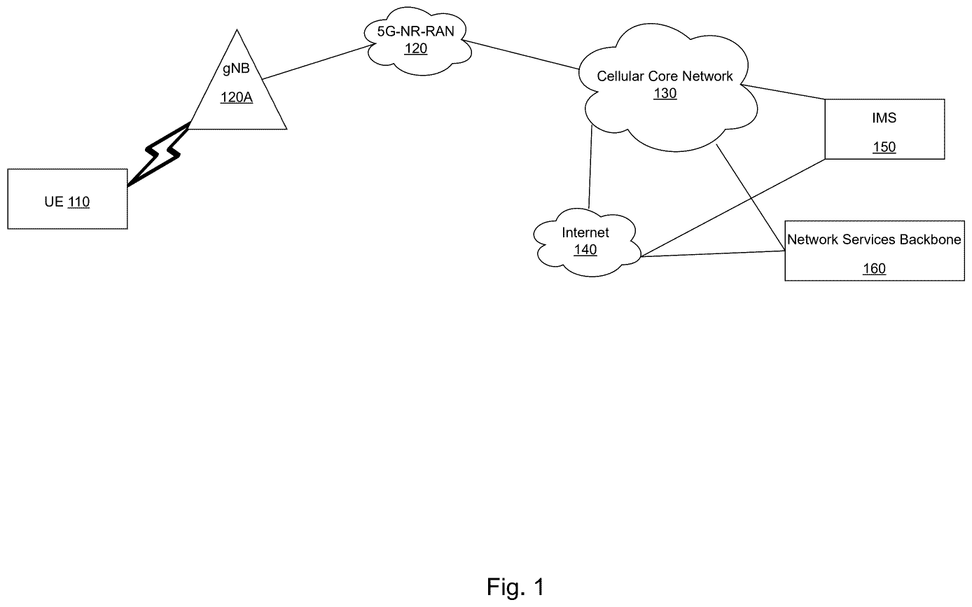

FIG. 1 shows an exemplary network arrangement 100 according to various exemplary embodiments. The exemplary network arrangement 100 includes a UE 110. Those skilled in the art will understand that the UE 110 may be any type of electronic component that is configured to communicate via a network, e.g., mobile phones, tablet computers, desktop computers, smartphones, phablets, embedded devices, wearables, Internet of Things (IoT) devices, etc. It should also be understood that an actual network arrangement may include any number of UEs being used by any number of users. Thus, the example of one UE 110 is merely provided for illustrative purposes.

The UE 110 may be configured to communicate with one or more networks. In the example of the network configuration 100, the network with which the UE 110 may wirelessly communicate is a 5G NR radio access network (RAN) 120. However, it should be understood that the UE 110 may also communicate with other types of networks (e.g., 5G cloud RAN, a next generation RAN (NG-RAN), a legacy cellular network, etc.) and the UE 110 may also communicate with networks over a wired connection. With regard to the exemplary embodiments, the UE 110 may establish a connection with the 5G NR PAN 120. Therefore, the UE 110 may have a 5G NR chipset to communicate with the NR RAN 120.

The 5G NR PAN 120 may be portions of a cellular network that may be deployed by a network carrier (e.g., Verizon, AT&T, T-Mobile, etc.). The PAN 120 may include cells or base stations that are configured to send and receive traffic from UEs that are equipped with the appropriate cellular chip set. In this example, the 5G NR PAN 120 includes the gNB 120A. However, reference to a gNB is merely provided for illustrative purposes, any appropriate base station or cell may be deployed (e.g., Node Bs, eNodeBs, HeNBs, eNBs, gNBs, gNodeBs, macrocells, microcells, small cells, femtocells, etc.).

Those skilled in the art will understand that any association procedure may be performed for the UE 110 to connect to the 5G NR PAN 120. For example, as discussed above, the 5G NR RAN 120 may be associated with a particular network carrier where the UE 110 and/or the user thereof has a contract and credential information (e.g., stored on a SIM card). Upon detecting the presence of the 5G NR PAN 120, the UE 110 may transmit the corresponding credential information to associate with the 5G NR PAN 120. More specifically, the UE 110 may associate with a specific cell (e.g., gNB 120A).

The network arrangement 100 also includes a cellular core network 130, the Internet 140, an IP Multimedia Subsystem (IMS) 150, and a network services backbone 160. The cellular core network 130 manages the traffic that flows between the cellular network and the Internet 140. The IMS 150 may be generally described as an architecture for delivering multimedia services to the UE 110 using the IP protocol. The IMS 150 may communicate with the cellular core network 130 and the Internet 140 to provide the multimedia services to the UE 110. The network services backbone 160 is in communication either directly or indirectly with the Internet 140 and the cellular core network 130. The network services backbone 160 may be generally described as a set of components (e.g., servers, network storage arrangements, etc.) that implement a suite of services that may be used to extend the functionalities of the UE 110 in communication with the various networks.

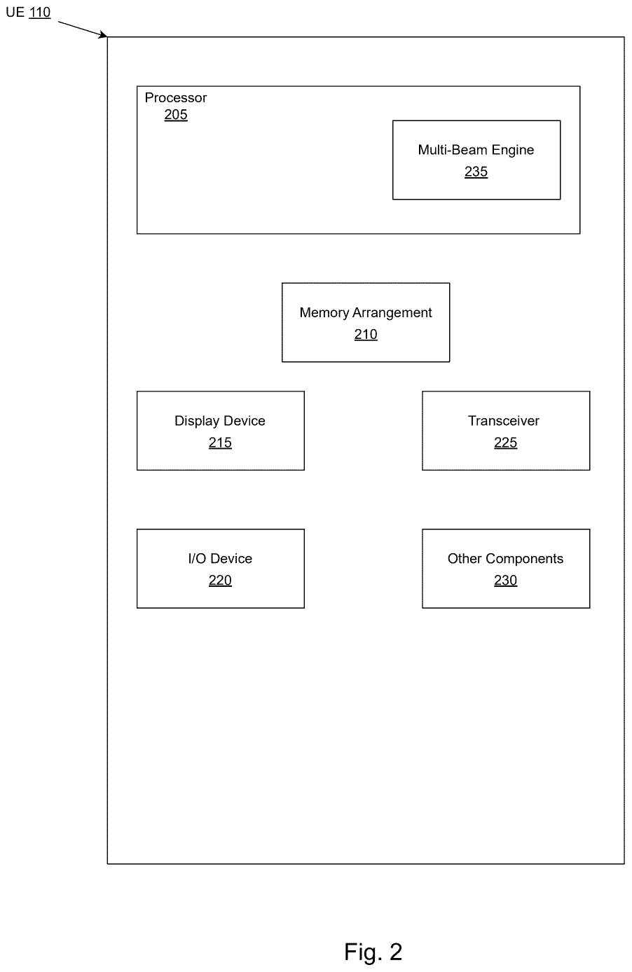

FIG. 2 shows an exemplary UE 110 according to various exemplary embodiments. The UE 110 will be described with regard to the network arrangement 100 of FIG. 1. The UE 110 may represent any electronic device and may include a processor 205, a memory arrangement 210, a display device 215, an input/output (I/O) device 220, a transceiver 225, and other components 230. The other components 230 may include, for example, an audio input device, an audio output device, a battery that provides a limited power supply, a data acquisition device, ports to electrically connect the UE 110 to other electronic devices, sensors to detect conditions of the UE 110, etc.

The processor 205 may be configured to execute a plurality of engines for the UE 110. For example, the engines may include a multi-beam engine 235 for performing operations such as beam failure detection (BFD), candidate beam detection (CBD), and beam failure recovery (BFR).

The above referenced engine being an application (e.g., a program) executed by the processor 205 is only exemplary. The functionality associated with the engines may also be represented as a separate incorporated component of the UE 110 or may be a modular component coupled to the UE 110, e.g., an integrated circuit with or without firmware. For example, the integrated circuit may include input circuitry to receive signals and processing circuitry to process the signals and other information. The engines may also be embodied as one application or separate applications. In addition, in some UEs, the functionality described for the processor 205 is split among two or more processors such as a baseband processor and an applications processor. The exemplary embodiments may be implemented in any of these or other configurations of a UE.

The memory arrangement 210 may be a hardware component configured to store data related to operations performed by the UE 110. The display device 215 may be a hardware component configured to show data to a user while the I/O device 220 may be a hardware component that enables the user to enter inputs. The display device 215 and the I/O device 220 may be separate components or integrated together such as a touchscreen. The transceiver 225 may be a hardware component configured to establish a connection with the 5G-NR PAN 120. Accordingly, the transceiver 225 may operate on a variety of different frequencies or channels (e.g., set of consecutive frequencies).

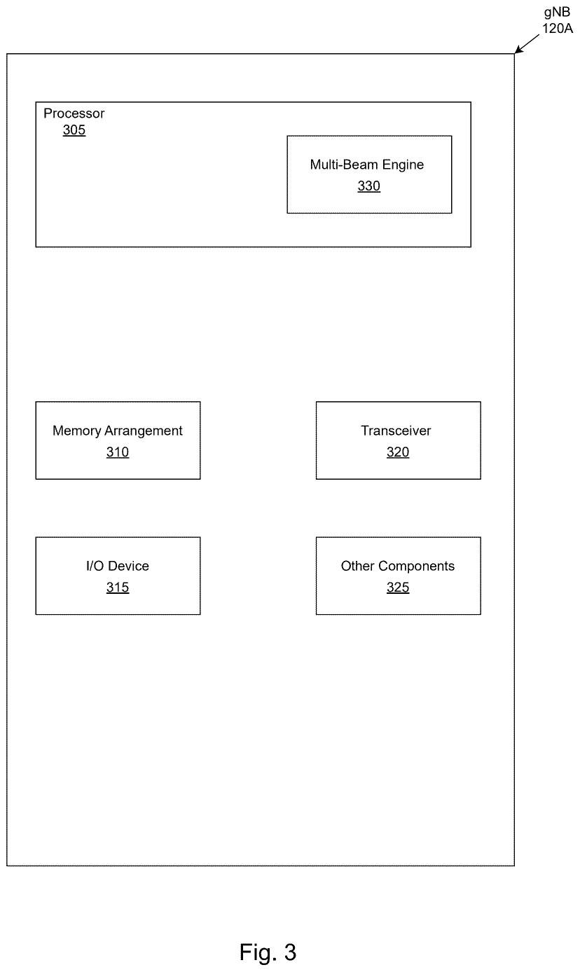

FIG. 3 shows an exemplary base station 300 according to various exemplary embodiments. The base station 300 may represent the gNB 120A or any other access node through which the UE 110 may establish a connection and manage network operations.

The base station 300 may include a processor 305, a memory arrangement 310, an input/output (I/O) device 315, a transceiver 320, and other components 325. The other components 325 may include, for example, an audio input device, an audio output device, a battery, a data acquisition device, ports to electrically connect the base station 300 to other electronic devices and/or power sources, etc.

The processor 305 may be configured to execute a plurality of engines for the UE 110. For example, the engines may include a Multi-Beam Engine 330 for performing operations related to beam failure detection (BFD), candidate beam detection (CBD), and beam failure recovery (BFR).

The memory 310 may be a hardware component configured to store data related to operations performed by the base station 300. The I/O device 315 may be a hardware component or ports that enable a user to interact with the base station 300. The transceiver 320 may be a hardware component configured to exchange data with the UE 110 and any other UE in the network arrangement 100. The transceiver 320 may operate on a variety of different frequencies or channels (e.g., set of consecutive frequencies). Therefore, the transceiver 320 may include one or more components (e.g., radios) to enable the data exchange with the various networks and UEs.

In situations where two simultaneous DL receptions (e.g., two AoA receptions), procedures are needed such that both the network and the UE ensure that the UE receives both a new beam corresponding to an AoA₂ and an existing beam corresponding to an AoA₁ simultaneously. UEs operating in such scenarios may alternatively fall back to single DL (e.g., with AoA₁) reception, or the UE may resume two AoA reception by following procedures defined herein.

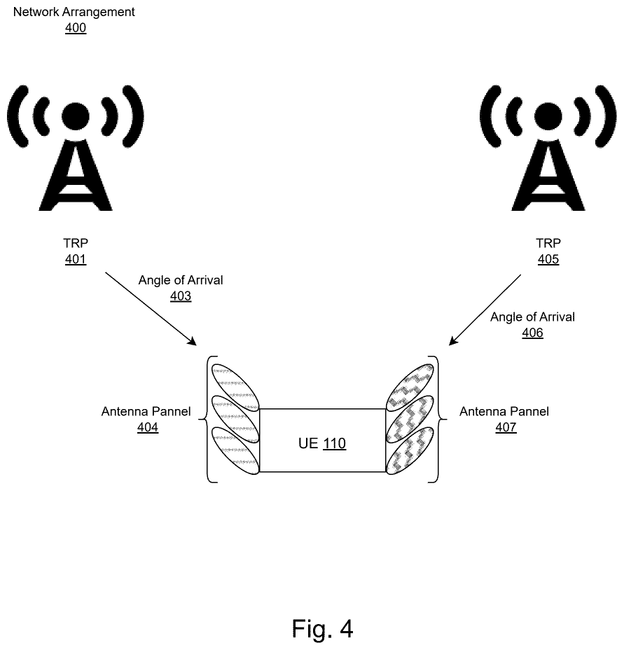

FIG. 4 shows an exemplary network arrangement 400 with two TRPs, according to various exemplary embodiments. Networking arrangement 400 illustrates the core concept of multiple TRPs, as well as multiple angles of arrival to a UE. The UE 110 is depicted with two antenna panels 404 and 407. One of skill in the art will recognize that antenna panels may be understood as subcomponents of transceiver 225.

Network arrangement 400 features a first TRP 401 and a second TRP 405. The TRPs 401 and 405 communicate with UE 110 via transmit beams with AoA 403 being received by antenna panel 404 of the UE 110, and AoA 406 being received by antenna panel 407 of the UE 110. One of skill in the art will understand that a UE may have a plurality of antenna panels. Each antenna panel (e.g., 404 and 407) may be in communication with a different TRP. While FIG. 4 is shown with two antenna panels and two TRPs, this is only exemplary and other quantities of antenna panels and TRPs in communication with a UE are possible. It is also possible that TRPs may occupy the same physical location or device, despite FIG. 4 depicting TRPs 401 and 405 as distinct entities.

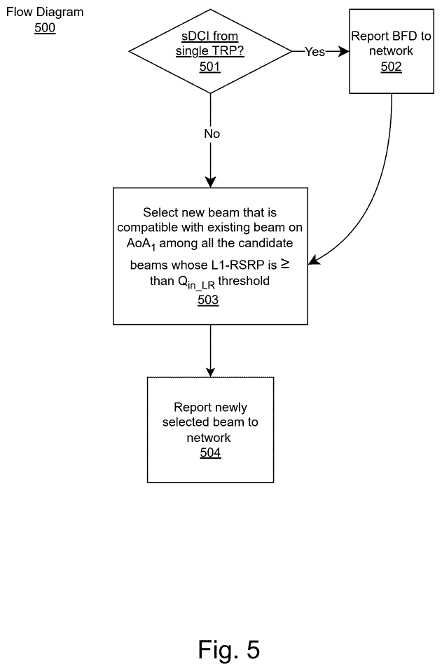

In a first aspect of the exemplary embodiments, UE detection of beam failure and candidate beam detection for multi-receiver chain downlink reception is disclosed herein. When a UE (e.g., UE 110) detects a beam failure on an AoA (e.g., AoA 406) and triggers a BFR procedure for AoA 406, there are two variants. FIG. 5 may be understood to be applicable to the first of the two variants of the first aspect.

FIG. 5 shows a first flow diagram 500 for UE BFR operations according to various exemplary embodiments. Flow diagram 500 is applicable to situations in which a UE (e.g., UE 110) has identified a BFD, initiated a BFR and must select a new beam (e.g., a candidate beam) through CBD. As will be described in greater detail below, the criteria for selecting the new beam is not limited to a beam with the best signal quality, but rather a beam that satisfies signal quality requirements and is capable of coexisting with the existing beam. In this example, it may be considered that the beam that has failed is the beam for receiving AoA₂, and the new beam that is to be selected is capable of coexisting with the existing beam for receiving AoA₁ (e.g., the UE 110 can receive both the new beam and the existing beam simultaneously). Reference to AoA₁ and AoA₂ may be understood as analogous to AoA 403 and AoA 406 illustrated in FIG. 4, though this is only exemplary. One of skill in the art will recognize that the exemplary embodiments pertain to situations when one beam fails; there is no relevance to the ordinal definitions of the beams (e.g., either beam can be defined as a first beam).

The manner of determining if a candidate beam is capable of coexisting with the existing beam may be up to UE implementation. In some exemplary embodiments, a general procedure may be that the UE will, through Layer-1 (L1) measurements, estimate the Reference Signal Received Power (RSRP) for each beam. If both beams have a satisfactory RSRP, and if the mutual interference between the two beams can be adequately addressed to make sure Rx signals from the two beams can be correctly decoded in the UE receiver, the UE will determine the two beams can coexist, e.g., be received simultaneously. However, it should be understood that this is one exemplary manner of determining whether beams can coexist. The exemplary embodiments should not be limited to the UE making the coexistence determination in any particular manner.

In some exemplary embodiments, it may be desirable that the UE 110 report BFD to the network quickly. In cases where the UE 110 is operating with a single downlink control information (sDCI) from a single TRP, there is likely to be substantial delay (of >100 slots) from the time that BFD is detected at the UE 110 to the time CBD is completed. Additionally, if DCI cannot be correctly received by the UE 110, the network may be unable to schedule the UE 110 for both DL reception or UL transmission, despite the adequate link quality of the second connected TRP. Thus, in some cases the UE 110 may report BFD to the network before selecting a new beam. This is described in greater detail below.

As part of selecting a new beam that is capable of coexisting with the existing beam, the CBD may be extended to allow for such an evaluation. Extending the CBD evaluation allows the network to determine whether the existing beam is compatible with the newly selected beam. This timing requirement may be defined as:

$$Max ( 25 , Ceil ( 3 \times P \times N \times {P}_{CBD} ) \times {T}_{SSB} + Δ )$$

where Max is the maximum value of the set, 25 refers to 25 ms, ceil is the ceiling function, P is the periodicity, N is the number of candidate beams, P_{CBD} refers the periodicity of candidate beam detection, T_{SSB} is the periodicity of SSB in the set, and A is the additional time.

Referring to FIG. 5, in 501, it may be considered that the UE 110 has detected a beam failure. If the UE 110 has a sDCI configuration from a single TRP, the UE 110 proceeds to 502. In 502, the UE 110 reports BFD immediately to the network. Reception of the notification 502 may cause the network to switch the sDCI from a failed TRP (e.g., TRP 405) to a working TRP (e.g., TRP 401).

From either 501 or 502, the method proceeds to 503 where the UE 110 selects a new beam. As described above, the criteria for selecting the new beam is a beam that satisfies signal quality requirements and is capable of coexisting with the existing beam. The candidate beams may be expressed as all beams whose Layer-1 Reference Signal Received Power (L1-RSRP) is equal to or greater than a threshold (Q_{in_LR}). As described above, the time for performing the CBD may be extended to account for determining if the candidate beams are capable of coexisting with the existing beam.

Once a candidate beam is selected, in 504, the UE 110 may report the selected beam to the network. The selected beam may be reported by, for example, UCI (Uplink Control Information), MAC CE, or Radio Resource Control (RRC) signaling via a MAC CE, etc. In some exemplary embodiments, an existing MAC CE may be modified because transmission of BFD before CBD is completed is outside the existing standards-based (e.g., 3GPP standards) operations. In the case of carrier aggregation, the reporting may be based on the BFR MAC CE for the Secondary Cell (SCell).

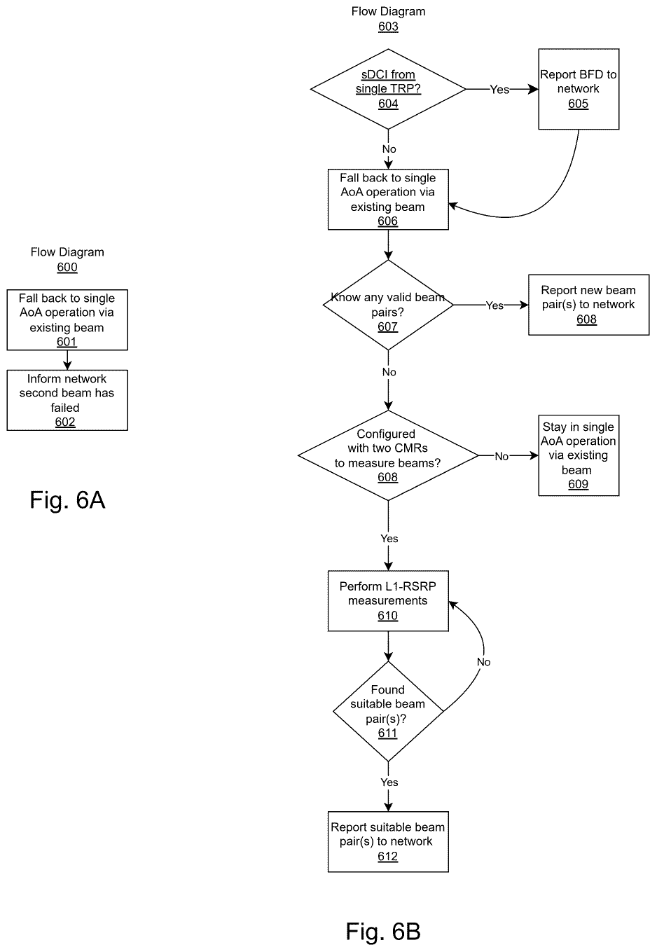

In a second variant of the first aspect, operations are disclosed for situations in which a UE is unable to find a new beam via CBD for AoA₂ that is compatible with an ongoing AoA₁. FIG. 6A and FIG. 6B show UE operations according to such a scenario.

FIG. 6A shows a second flow diagram 600 for UE BFR operations according to various exemplary embodiments. In a first alternate of the second variant, in 601 the UE (e.g., UE 110) may fall back to single AoA operations, thereby minimizing interruptions by using the ongoing (e.g., live or active) beam. In 602, the UE 110 may inform the network that an AoA₂ (e.g., AoA 406) has failed (e.g., BFD) via a UCI, MAC CE, RRC, etc.

As stated above, it should be understood that reference to an AoA₂ does not imply an ordinal relationship, that is, either AoA₁ or AoA₂ may be defined as “first” without altering the scope of the exemplary embodiments. One of skill in the art will recognize the pertinent point that one of the two beams has failed.

The second alternate of the second variant may be applicable to situations where a sDCI is configured and transmitted from a single TRP. FIG. 6B shows a third flow diagram 603 for UE BFR operations according to various exemplary embodiments. In 604, the UE 110 determines if it is operating with an sDCI configuration with the DCI being transmitted from a single TRP (e.g., TRP 401). If it is, the UE 110 proceeds to 605, in which the UE 110 reports BFD to the network via UCI or a MAC CE. Reception of the report 605 by the network allows for faster switching of sDCI from the failed TRP (e.g., TRP 405).

Following 605, or directly from 604 (if the answer to 604 is no), the UE 110 proceeds to 606. In 606, the UE 110 falls back to single AoA operations via the existing (e.g., live or active) beam.

In 607, the UE 110 determines whether there are any additional available beam pairs it can support. Based on prior beam reporting to the network (not shown) the UE 110 may be already aware of one or more beam pairs it can immediately use following beam failure. If there are valid known beam pairs, the UE 110 proceeds to 608, where it reports the new beam pairs to the network.

In 608, the UE 110 determines whether it is configured with two channel measurement resource (CMR) sets for beam measurement. If the answer to 608 is yes, the UE 110 will conduct L1-RSRP measurements in 610. If the answer to 607 is no, the UE 110 proceeds to 609 and stays in single AoA operations via the existing beam.

In 611, the UE determines if it has found a suitable beam pair (e.g., a beam that is compatible with the existing beam). Measured beams that are not suitable may also be referred to as sub-candidate beams. If it has not, the UE 110 returns to 610 to perform further measurements. If the UE 110 has found a suitable beam pair, it proceeds to 612, in which the UE 110 reports the new beam pair it can support via a group-based beam reporting mechanism to the network.

In a third aspect of the exemplary embodiments, UCI-based reporting of new beam(s) or BFD to the network is disclosed herein. In a first alternative of the third aspect, the UCI may be considered to be a special Channel State Information (CSI) feedback. The priority of the first alternative UCI may have a same priority as existing CSI (e.g., L1-RSRP or L1-Signal to Interference plus Noise Ratio (SINR)).

In a second alternative, the UCI may be a newly defined UCI, which would exist in addition to existing UCI types such as SR/HARQ-ACK/CSI/CG UCIs. This new UCI may be encoded standalone using polar code, or it may be jointly encoded with other types of UCI with polar code.

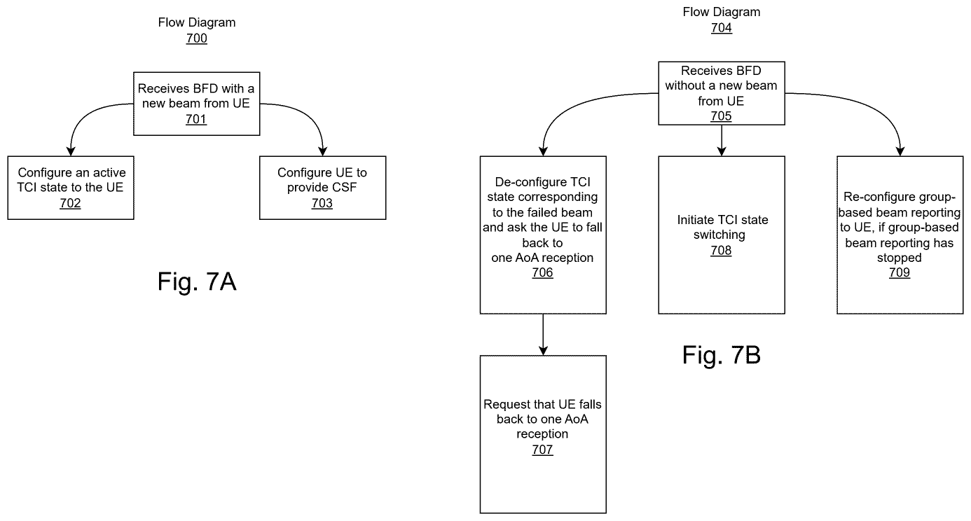

In a fourth aspect of the exemplary embodiments, network behavior for BFD/CBD for multi-RX reception is disclosed herein. FIG. 7A shows a first flow diagram 700 for network behavior for BFD/CBD according to various exemplary embodiments. In 701, the network receives a BFD with a new beam from a UE (e.g., UE 110). Following 701, the network may perform two alternative operations. Operations 702 and 703 should be understood to be alternative behaviors for the network.

In a first alternative (shown by 702), the network may configure an active transmission configuration indicator (TCI) state based on the new beam received in 701. Following 702, the UE may now receive again with two downlinks (via both beams).

In a second alternative (shown by 703), the network configures the UE to provide channel state feedback (CSF) to the network. This channel state feedback may be a channel quality indicator, a rank indicator, and/or a precoding matrix indicator. The network may configure the UE by configuring a CSI process unit (CPU) for the UE to report CSF.

FIG. 7B shows a second flow diagram 704 for network behavior for BFD/CBD according to various exemplary embodiments. In 705, the network receives a BFD from a UE without a new beam (e.g., the BFD notification does not contain a new beam). Operations 706, 708, and 709 may be understood to be three different alternatives to the scenario of 705.

In a first alternative shown in 706, the network de-configures a TCI state corresponding to a failed beam. In 707, the network transmits a request to the UE 110 to fall back to one AoA reception (i.e., single beam).

In a second alternative shown in 708, the network may initiate TCI state switching. Enabling TCI state switching may allow the UE 110 to determine a new beam pair if the UE 110 reports a new beam pair during group-based beam reporting (for example, 607 and 608 in FIG. 6B).

In a third alternative shown in 709, the network may re-configure group-based beam reporting to the UE 110, if group-based beam reporting has stopped. This may allow the UE 110 to continue measuring for a suitable pair of beams.

For operations 706, 708, and 709 (the three alternatives) the network may configure CBD resources in q̅₁ in such a way that the CBD RS resources in q̅₁ are configured for each TRP that can be linked to two channel measurement resource (CMR) sets. CBD resources for each TRP may be included in a CMR set for each TRP. In this scenario, the likelihood that a new beam chosen from the CBD RSs is compatible with the existing beam for the other AoA is increased.

### EXAMPLES

In a first example, a method is performed by a base station that is communicating with a user equipment using a first beam from a first transmission and reception point and a second beam from a second TRP, the method comprising receiving a beam failure detection (BFD) notification from the UE indicating that the first beam of the first TRP has experienced a beam failure and determining whether the BFD notification comprises a new candidate beam to communicate with the UE using the first TRP.

In a second example, the method of the first example, further comprising generating a channel measurement resource (CMR) set for each TRP, the two CMR sets further comprising one or more configured candidate beam detection (CBD) reference signal (RS) resources for the first and second TRP, respectively and transmitting an indication of the CMR sets to the UE.

In a third example, the method of the first example, wherein the BFD notification is received via a Medium Access Control (MAC) Control Element (CE), uplink control information (UCI) or Radio Resource Signaling (RRC).

In a fourth example, the method of the third example, wherein the BFD notification is received via UCI as Channel State Information (CSI) feedback.

In a fifth example, the method of the third example, wherein the BFD notification is received via UCI that is standalone encoded using polar code or is jointly encoded with other types of UCI using polar code.

Those skilled in the art will understand that the above-described exemplary embodiments may be implemented in any suitable software or hardware configuration or combination thereof. An exemplary hardware platform for implementing the exemplary embodiments may include, for example, an Intel x86 based platform with compatible operating system, a Windows OS, a Mac platform and MAC OS, a mobile device having an operating system such as iOS, Android, etc. The exemplary embodiments of the above described method may be embodied as a program containing lines of code stored on a non-transitory computer readable storage medium that, when compiled, may be executed on a processor or microprocessor.

Although this application described various embodiments each having different features in various combinations, those skilled in the art will understand that any of the features of one embodiment may be combined with the features of the other embodiments in any manner not specifically disclaimed or which is not functionally or logically inconsistent with the operation of the device or the stated functions of the disclosed embodiments.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

It will be apparent to those skilled in the art that various modifications may be made in the present disclosure, without departing from the spirit or the scope of the disclosure. Thus, it is intended that the present disclosure cover modifications and variations of this disclosure provided they come within the scope of the appended claims and their equivalent.

1. A method performed by a user equipment (UE) communicating with a base station comprising a first transmission and reception point (TRP) and a second TRP, the method comprising:
determining a beam failure for a first beam transmitted by the first TRP; and
performing a candidate beam detection (CBD) operation to evaluate candidate beams for communicating with the first TRP, wherein the CBD operation comprises determining whether each candidate beam is compatible with an active beam being transmitted to the UE by the second TRP.

2. The method of claim 1, further comprising:
selecting one of the candidate beams to communicate with the first TRP; and
transmitting, to the base station, information identifying the one of the candidate beams.

3. The method of claim 1, wherein the information identifying the one of the candidate beams to the network is transmitted via a Medium Access Control (MAC) Control Element (CE), uplink control information (UCI) or Radio Resource Signaling (RRC).

4. The method of claim 3, wherein the information is transmitted via UCI as Channel State Information (CSI) feedback, wherein the CSI feedback has a priority equal to L1-Reference Signal Received Power (RSRP) CSI feedback.

5. The method of claim 3, wherein the information is transmitted via UCI that is standalone encoded using polar code or is jointly encoded with other types of UCI using polar code.

6. The method of claim 1, wherein evaluating the candidate beams comprises determining whether each candidate beam satisfies a beam quality threshold.

7. The method of claim 1, further comprising:
when the UE is configured with a single downlink control information (sDCI) configuration transmitted from one of the first or second TRPs, transmitting a beam failure detection (BFD) notification to the base station prior to completing the CBD operations, wherein the BFD notification indicates the beam failure.

8. The method of claim 7, wherein the BFD notification is transmitted via uplink control information (UCI) or Medium Access Control (MAC) Control Element (CE).

9. The method of claim 8, wherein the BFD notification is transmitted via UCI as Channel State Information (CSI) feedback, wherein the CSI feedback has a priority equal to L1-Reference Signal Received Power (RSRP) CSI feedback.

10. The method of claim 8, wherein the BFD notification is transmitted via UCI that is standalone encoded using polar code or is jointly encoded with other types of UCI using polar code.

11. The method of claim 1, wherein, when the UE cannot identify one of the candidate beams that is compatible with the active beam, the method further comprises:
performing a fallback operation.

12. The method of claim 11, wherein the fallback operation comprises switching to a single-beam operating mode using the active beam communicating with the second TRP.

13. The method of claim 12, further comprising:
transmitting a beam failure detection (BFD) notification to the network via a MAC CE indicating the beam failure of the first beam.

14. The method of claim 11, wherein the fallback operation comprises:
when the UE is configured with a single downlink control information configuration (sDCI) that is transmitted from one of the first or second TRPs, transmitting a beam failure detection (BFD) notification to the network prior to completing the CBD operations.

15. The method of claim 14, wherein the fallback operations comprise:
reporting, to the base station, a candidate beam pair that the UE supports, wherein the candidate beam pair does not include the active beam currently being transmitted by the second TRP and wherein the reporting is performed using group-based beam reporting.

16. The method of claim 15, wherein the fallback operations further comprise:
when the UE is configured with two channel measurement resource (CMR) sets, performing L1-Reference Signal Received Power (RSRP) measurements on one or more candidate beam pairs, wherein the candidate beam pair is selected from the candidate beam pairs.

17. A method performed by a base station that is communicating with a user equipment using a first beam from a first transmission and reception point and a second beam from a second TRP, the method comprising:
receiving a beam failure detection (BFD) notification from the UE indicating that the first beam of the first TRP has experienced a beam failure; and
determining whether the BFD notification comprises a new candidate beam to communicate with the UE using the first TRP.

18. The method of claim 17, wherein, when the BFD notification comprises the new candidate beam, the method further comprises:
transmitting a configuration to the UE comprising an active transmission configuration indicator (TCI) state for the new candidate beam.

19. The method of claim 17, wherein, when the BFD notification comprises the new candidate beam, the method further comprises:
transmitting a configuration to the UE indicating the UE is to perform measurements using the new candidate beam to provide channel state feedback to the base station.

20. The method of claim 17, wherein, when the BFD notification does not comprise the new candidate beam, the method further comprises:
de-configuring a transmission configuration indicator (TCI) state corresponding to the first beam; and
configuring the UE to fallback to single-beam reception using the second beam from the second TRP.

21-22. (canceled)
